(19) United States
(12) Patent Application Publication
(10) Pub. No.: US 2018/0072964 A1
(43) Pub. Date: Mar. 15, 2018

(54) ORGANIC CANDLE

(71) Applicant: Nature Labs, LLC, Vineland, NJ (US)

(72) Inventor: Johanna Guzman, Medford, NJ (US)

(21) Appl. No.: 15/701,902

(22) Filed: Sep. 12, 2017

Related U.S. Application Data
(60) Provisional application No. 62/393,899, filed on Sep. 13, 2016.

(51) Int. Cl. C11C 5/00; C11C 5/02; F23D 3/16

(52) U.S. Cl. CPC C11C 5/002; F23D 3/16; C11C 5/023; C11C 5/006

(57) ABSTRACT

Organic candles of palm oil, coconut oil, beeswax, and one or more essential oils and methods for their production are provided.

This patent application claims the benefit of priority from U.S. Provisional Application Ser. No. 62/393,899, filed Sep. 13, 2016, teachings of which are herein incorporated by reference in their entirety.

### FIELD OF THE INVENTION

The present invention relates to organic candles of palm oil, coconut oil, beeswax, and essential oils and methods for their production.

### BACKGROUND OF THE INVENTION

Candles have been known and used for illumination since early civilization. The Egyptians are believed to have soaked the pithy cores of reeds in molten tallow to produce rushlights or torches while the Romans produced candles with wicks from tallow derived from cattle and sheep suet. Around the middle ages, beeswax was found to be desirable for use in candles as beeswax does not produce a smoky flame or emit any unpleasant odor when burned. However, beeswax was expensive, leading candlemakers to pursue alternative sources.

During the Industrial Revolution machines were developed to produce paraffin wax and candles from this wax. Paraffin, a bluish-white wax, burns cleanly with no unpleasant odor and is economical to produce. However, paraffin alone has a low melting point and typically requires addition of stearic acid, a by-product of animal fat for candle production. Recently, environmental, health and supply concerns have been raised with respect to use of petroleum byproducts in candles.

Accordingly, candle wax formulations based upon natural materials such as vegetable oils have been proposed. However, the production of candles from these waxes has suffered several drawbacks, including cracking, air pocket formation, product shrinkage and a natural product odor associated with vegetable materials. Various soybean-based waxes have been reported to suffer performance problems relating to optimum flame size, effective wax and wick performance matching for an even burn, maximum burning time, failure to achieve a consistent appearance upon resolidification after melting, product color integration and/or product shelf life.

Further, there are multiple types of candles, including for example, tapers, votives, pillars and container candles and the like, each of which has unique wax requirements. For example, container candles, where the wax and wick are held in a container, typically glass, metal or the like, require lower melting points, specific burning characteristics such as wider melt pools, and should desirably adhere to the container walls. The melted wax should preferably retain a consistent appearance upon resolidification.

### SUMMARY OF THE INVENTION

An aspect of the present invention relates to a candle, the majority of which comprises organic materials. Candles of the present invention comprise a wax of organic palm oil, organic coconut oil, organic beeswax and one or more organic essential oils. Candles of the present invention may further comprise one or more organic wicks.

Another aspect of the present invention relates to a method for production of a candle, the majority of which comprises organic materials. In this method, organic coconut oil, organic palm oil and organic beeswax are added to a tank capable of mixing, heating and cooling and heated to a temperature of 75-80° C. The resulting mixture is then cooled to 60-65° C. and one or more organic essential oils are added and mixed thoroughly. When the mixture reaches 55-60° C., it is added to a candle container pre-heated to 20-40° C. and then cooled to room temperature. In one nonlimiting embodiment, one or more wicks are pre-placed in the container and cooled to room temperature.

### DETAILED DESCRIPTION OF THE INVENTION

The present invention relates to candles comprising a majority of organic materials and methods for their production.

By “majority”, as used herein, it is meant that the candle, excluding any container, comprises more than 50% organic materials. In one nonlimiting embodiment, more than 60% of the candle is comprised of organic material. In one nonlimiting embodiment, more than 70% of the candle is comprised of organic material. In one nonlimiting embodiment, more than 75% of the candle is comprised of organic material. In one nonlimiting embodiment, more than 80% of the candle is comprised of organic material. In one nonlimiting embodiment, more than 85% of the candle is comprised of organic material. In one nonlimiting embodiment, more than 90% of the candle is comprised of organic material. In one nonlimiting embodiment, 100% of the candle is comprised of organic material.

By “organic” as used herein, it is meant that the oils, wax and/or wick as well as candle production methods used allow for labeling candles or components of the candles of the present invention as “USDA Certified Organic” in accordance with the uniform national standards set forth at nal with the extension usda.gov/afsic/organic-productionorganic-food-information-access-tools#define of the world wide web.

The candles of the present invention comprise a wax of palm oil, coconut oil, beeswax, and one or more essential oils, wherein one or more of these components of the wax are organic. In one nonlimiting embodiment, the wax of the candle comprises 55-65% of organic palm oil. In one nonlimiting embodiment, the wax of the candle comprises 15-25% of organic coconut oil. In one nonlimiting embodiment, the wax of the candle comprises 10-20% of organic beeswax. In one nonlimiting embodiment, the wax of the candle comprises 2-10% of one or more organic essential oils. In one nonlimiting embodiment, the wax of the candle comprises 55-65% of organic palm oil, 15-25% of organic coconut oil, 10-20% of organic beeswax and 2-10% of one or more organic essential oils. The inventor herein has found that candles of this wax exhibit optimum flame size, effective wax and wick performance matching for an even burn, maximum burning time, a consistent appearance upon resolidification after melting, product color integration, product shelf life, a lower melting point, and specific burning characteristics such as wider melt pools, and/or adherence to the container walls.

Candles of the present invention may further comprise one or more wicks. In one nonlimiting embodiment, the wick is an organic wick. Examples of organic wicks include, but are not limited to organic cotton wicks, organic hemp wicks and organic wood wicks. In one nonlimiting embodiment, the organic wick is cotton. In another nonlimiting embodiment, the wick is synthetic.

Candles of the present invention can be produced by various methods. In one nonlimiting embodiment, coconut oil, palm oil and beeswax are added to a tank capable of mixing, heating and cooling. The oils and beeswax are then heated to a temperature of 75-80° C. The resulting mixture is then cooled to 60-65° C. and one or more essential oils are added and mixed thoroughly.

In one nonlimiting embodiment, one or more of the oils and/or beeswax are organic. In one nonlimiting embodiment, organic palm oil is included in an amount of 55-65%, organic coconut oil in included in an amount of 15-25%, organic beeswax is included in an amount of 10-20% and one or more organic essential oils is included in an amount of 2-10%.

When the mixture cools to 55-60° C., it is added to a candle container preheated to 20-40° C. and then cooled to room temperature. In one nonlimiting embodiment, one or more wicks are pre-placed in the candle container prior to adding the mixture. In one nonlimiting embodiment, the wick or wicks are organic. Examples of organic wicks include, but are not limited to, organic cotton wicks, organic hemp wicks and organic wood wicks. In one nonlimiting embodiment, the wick is an organic cotton wick. In another nonlimiting embodiment, the wick is synthetic.

What is claimed is:

1. A candle comprising a wax of palm oil, coconut oil, beeswax and one or more essential oils, wherein a majority of the oils and beeswax are organic.

2. The candle of claim 1 further comprising a wick.

3. The candle of claim 2 wherein the wick is organic.

4. The candle of claim 3 wherein the organic wick comprises cotton.

5. The candle of claim 1 wherein more than 60% of the candle is organic.

6. The candle of claim 1 wherein more than 70% of the candle is organic.

7. The candle of claim 1 wherein more than 75% of the candle is organic.

8. The candle of claim 1 wherein more than 80% of the candle is organic.

9. The candle of claim 1 wherein more than 85% of the candle is organic.

10. The candle of claim 1 wherein more than 90% of the candle is organic.

11. The candle of claim 1 wherein 100% of the candle is organic.

12. The candle of claim 1 wherein the wax is comprised of 55-65% organic palm oil.

13. The candle of claim 1 wherein the wax is comprised of 15-25% organic coconut oil.

14. The candle of claim 1 wherein the wax is comprised of 10-20% organic beeswax.

15. The candle of claim 1 wherein the wax is comprised of 2-10% of one or more organic essential oils.

16. The candle of claim 1 wherein the wax is comprised of 55-65% organic palm oil, 15-25% organic coconut oil, 10-20% organic beeswax and 2-10% of one or more organic essential oils.

17. A method for producing the candle of claim 1, said method comprising:
(a) adding coconut oil, palm oil and beeswax to a tank capable of mixing, heating and cooling;
(b) heating the coconut oil, palm oil and beeswax in the tank to a temperature of 75-80° C. to form a melted mixture;
(c) cooling the melted mixture to 60-65° C.;
(d) adding and thoroughly mixing one or more organic essential oils to the mixture of step (c);
(e) cooling the mixture of step (d) to 55-60° C.,
(f) adding the cooled mixture to a pre-heated candle container; and
(g) cooling the mixture in the candle container to room temperature to form a candle.

18. The method of claim 17 wherein one or more wicks are placed in the candle container prior to adding the cooled mixture in step (f).
